(19) United States
(12) Patent Application Publication
(10) Pub. No.: US 2026/0287732 A1
(43) Pub. Date: Sep. 24, 2026

(54) METHODS AND SYSTEMS FOR DETECTING BROKEN GLASS

(71) Applicant: Alps Alpine Co., Ltd., Tokyo (JP)

(72) Inventors: Prudencio CABIGAO, Auburn Hills, MI (US); Levi HELLEBUYCK, Shelby Township, MI (US); Robert CHENE, Auburn Hills, MI (US)

(21) Appl. No.: 19/082,768

(22) Filed: Mar. 18, 2025

(51) Int. Cl. G01S 13/88; B60R 25/34; G01S 7/41

(52) U.S. Cl. CPC G01S 13/886; B60R 25/34; G01S 7/412

(57) ABSTRACT

A radar array for detecting whether a window of a vehicle is intact. The radar array includes a plurality of transmitter antennas and a plurality of receiver antennas. Each of the plurality of transmitter antennas are configured to transmit a signal and each of the plurality of receiver antennas are configured to receive the signals transmitted by the plurality of transceiver antennas. The radar array is configured to detect whether a window is intact based on the signals received by the plurality of receiver antennas relative to a baseline.

### FIELD

The present disclosure relates to systems and methods for detecting broken glass, particularly in a vehicle.

### BACKGROUND

This section provides background information related to the present disclosure which is not necessarily prior art. Vehicle theft is a problem in society. Stealing a vehicle or items left on a seat of a vehicle often involves breaking a vehicle window to gain access to the inside of the vehicle. A deterrence mechanism for breaking vehicle windows is desired.

### BRIEF SUMMARY

This section provides a general summary of the disclosure and is not a comprehensive disclosure of its full scope or all of its features.

At least one example embodiment is a radar array for detecting whether a window of a vehicle is intact. The radar array may include a plurality of transmitter antennas and a plurality of receiver antennas. Each of the plurality of transmitter antennas may be configured to transmit a signal and each of the plurality of receiver antennas may be configured to receive the signals transmitted by the plurality of transmitter antennas. The radar array may be configured to detect whether a window is not intact (e.g., broken) based on the signals received by the plurality of receiver antennas.

In at least one example embodiment, there may be more receiver antennas in the plurality of receiver antennas than transmitter antennas in the plurality of transmitter antennas.

In at least one example embodiment, the radar array may be configured to determine a baseline signal received by the plurality of receiver antennas when the window is intact (e.g., not broken). In at least one example embodiment, the plurality of receiver antennas may be configured to detect that the window is not intact by comparing the signals received by the plurality of receiver antennas to the baseline signal.

In at least one example embodiment, the radar array may be further configured to cause an alert to be generated upon determining that the window is not intact (e.g., broken).

In at least one example embodiment, the signals transmitted by each of the plurality of transmitter antennas may be radio frequency (“RF”) signals. In at least one example embodiment, the RF signals may be between about 60 GHz and 144 GHz.

Also described herein is a method for detecting whether a window of a vehicle is not intact (e.g., broken). The method may include sending signals from each transmitter antenna of a plurality of transmitter antennas, receiving the signals from the plurality of transmitter antennas with a plurality of receiver antennas, and determining whether a window is not intact based on the signals received by the plurality of receiver antennas.

In at least one example embodiment, the method may further include placing a radar antenna in the vehicle. In at least one example embodiment, the radar antenna may include the plurality of transmitter antennas and the plurality of receiver antennas.

In at least one example embodiment, the method may further include determining a baseline signal received by the plurality of receiver antennas when the window is intact (e.g., not broken). In at least one example embodiment, determining whether a window is intact may include comparing the signals received at each of the plurality of receiver antennas to the baseline signal.

In at least one example embodiment, the method may further include determining an orientation of the window based on a placement of the plurality of receiver antennas and the signals received by each antenna of the plurality of receiver antennas. In at least one example embodiment, determining the placement of the window may include determining an angle of the window based on the signals received by each antenna of the plurality of receiver antennas and an amplitude of the signals received by each antenna of the plurality of receiver antennas.

In at least one example embodiment, the method may further include generating an alert upon determining that the window is not intact.

Also described herein is a radar system for detecting a condition of a window of a vehicle. The radar system may include a radar transmitter configured to send one or more signals and a radar receiver configured to receive the one or more signals sent by the radar transmitter. The radar system may further include a processor in communication with the radar transmitter and the radar receiver and a memory in communication with the processor. The memory may include instructions configured, when executed, to cause the processor to send an instruction to cause the radar transmitter to transmit one or more signal towards the window from within the vehicle, interpret a return signal received with the radar receiver, and determine, based on the return signal, a condition of the window.

In at least one example embodiment, the processor is further configured to determine a baseline signal received by the radar receiver when the window is intact (e.g., not broken). In at least one example embodiment, the processor may be configured to detect that a window is not intact by comparing the one or more signals received by the radar receiver to the baseline signal.

In at least one example embodiment, the processor may be further configured to generate an alert upon determining that the window is not intact.

In at least one example embodiment, the signal transmitted by the radar transmitter may be a radio frequency (“RF”) signal. In at least one example embodiment, the RF signal may be between about 60 GHz and 144 GHz.

### BRIEF DESCRIPTION OF THE SEVERAL VIEWS OF THE DRAWINGS

The drawings described herein are for illustrative purposes only of selected embodiments and not all possible implementations and are not intended to limit the scope of the present disclosure.

FIG. 1 is a radar array according to an example embodiment.

FIG. 2 is a block diagram of a system suitable for use with the radar array of FIG. 1 to implement the methods described herein according to an example embodiment.

FIG. 3 is an illustration of a plurality of transmitters of the radar array of FIG. 1 sending signals in a vehicle with an intact window according to an example embodiment.

FIG. 4 is an illustration of a plurality of receivers of the radar array of FIG. 1 receiving signals in a vehicle with an intact window according to an example embodiment.

FIG. 5 is an illustration of a plurality of transmitters of the radar array of FIG. 1 sending signals in a vehicle with a window that is not intact (e.g., broken) according to an example embodiment.

FIG. 6 is an illustration of a plurality of receivers of the radar array of FIG. 1 receiving signals in a vehicle with a window that is not intact (e.g., broken) according to an example embodiment.

FIG. 7 is an illustration of a receiver array receiving signals reflected from an intact window according to an example embodiment.

FIG. 8 is an illustration of a receiver array receiving signals reflected from a window that is not intact (e.g., broken) according to an example embodiment.

FIG. 9 is a flow chart of a method of detecting a window that is not intact (e.g., broken) of a vehicle according to an example embodiment.

FIG. 10 is a flow chart of a method of detecting a condition of a window of a vehicle according to an example embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, tasks, operations, elements, and/or components, but do not preclude the presence or addition of one or more other features, integers, tasks, operations, elements, components, and/or groups thereof. The method tasks, processes, and operations described herein are not to be construed as necessarily requiring their performance in the particular order discussed or illustrated, unless specifically identified as an order of performance. It is also to be understood that additional or alternative tasks may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a personal area network (PAN), a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (I) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments will now be described more fully with reference to the accompanying drawings.

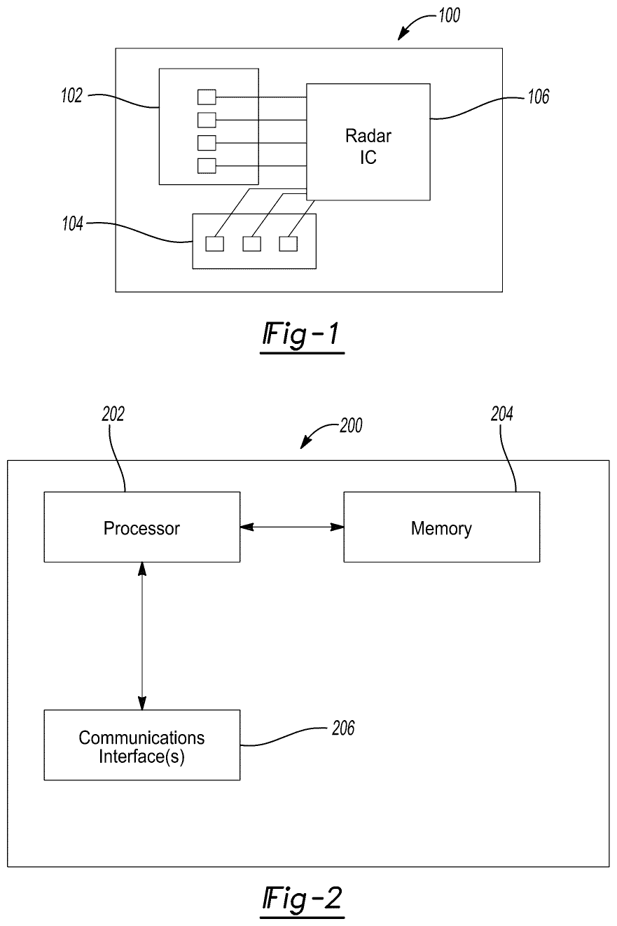

FIG. 1 is a radar array 100 that may be used to detect non-intact or broken glass in a vehicle. The radar array 100 may also be used to determine a condition of a vehicle window. A non-exhaustive list of window conditions may include, but is not limited to, determining whether the window is intact, whether the window is broken, whether the window is rolled down, whether the window is rolled up, whether the window is partially rolled up, another condition, or combinations thereof.

The radar array 100 may include a plurality of receiver antennas 102 and a plurality of transmitter antennas 104. The radar array 100 may also include an integrated circuit 106 coupled to the plurality of receiver antennas 102 and the plurality of transmitter antennas 104. In at least one example embodiment, the plurality of receiver antennas 102 and the plurality of transmitter antennas 104 may be transceivers that are configured to at least one of send or receive a signal.

In at least one example embodiment, there may be four receiver antennas in the plurality of receiver antennas 102 and there may be three transmitter antennas in the plurality of transmitter antennas 104. However, example embodiments are not limited herein. In at least one example embodiment, there may be more receiver antennas in the plurality of receiver antennas 102 than there are transmitter antennas in the plurality of transmitter antennas 104. In at least one example embodiment, there may be more receiver antennas in the plurality of receiver antennas 102 than there are transmitter antennas in the plurality of transmitter antennas 104 to increase an angular resolution of radar without substantially increasing cost or complexity of the radar array 100.

In at least one example embodiment, a radar system may include a sensor configured to send and receive a signal to determine whether a window is broken. The sensor may include a radar transmitter and a radar receiver as described above with respect to the radar array 100. In particular, the radar transmitter may be a transmitter antenna of the plurality of transmitter antennas 104 and the radar receiver may be a receiver antenna of the plurality of receiver antennas 102. The radar system may function as described herein with respect to the radar array 100 except there may be only one radar transmitter and one radar receiver. In at least one example embodiment, a radar transceiver may be used as both the radar transmitter and the radar receiver of the radar system. Further, the radar system may include a processor in communication with the radar transmitter and the radar receiver and a memory in communication with the processor. The memory may include instructions that, when executed by the processor, cause the processor to send an instruction to cause the radar transmitter to transmit one or more signals, interpret a return signal received by the radar receiver, and determine, based on the return signal, a condition of the window.

In at least one example embodiment, the plurality of transmitter antennas 104 are each configured to transmit a signal which is reflected upon contact with an object. The reflected signals are then received by the plurality of receiver antennas 102. The position of each of the receiver antennas of the plurality of receiver antennas 102 on the radar array 100 is known. Thus, based on the timing of the signals received at each of the receiver antennas of the plurality of receiver antennas 102, an angle of the reflected signals can be determined. These angles can be correlated to the location of where the signals are reflected. The radar array 100 may also be able to determine an amplitude of the signals received at each of the receiver antennas of the plurality of receiver antennas 102 based on an energy received at certain angles of the plurality of receiver antennas 102. Based on the determined angles and amplitudes, object positions may be determined. For example, the radar array 100 may be configured to determine an orientation of a glass window in a vehicle based on at least distance, amplitude, angle of arrival, and/or another characteristic of reflected signals received by the plurality of receiver antennas 102.

In at least one example embodiment, the signals transmitted by the plurality of transmitter antennas 104 are radio frequency (“RF”) signals. In at least one example embodiment, the RF signals may be between about 60 GHz and 144 GHz. However, these signals are not limited herein and may be adjusted based on requirements of the location of the vehicle where the radar array 100 is implemented. For example, the radar systems may operate in a range of 57.0 GHz to 64.0 GHz. In some examples, the power of a radar system may be within the 57.0 GHz to 64.0 GHz range may not exceed a power of 14 dBm peak equivalent, isotopically radiating power (“EIRP”) subject to a 22.7% duty cycle.

FIG. 2 is a block diagram of a system 200 that may be included in the integrated circuit 106 of the radar array 100 and/or within the radar system. The system 200 may be a computer or other architecture capable of performing the methods and functionality described herein. For example, the system 200 may be configured to communicate with the plurality of receiver antennas 102 and the plurality of transmitter antennas 104 to determine angles, amplitudes, and distances as described above in FIG. 1.

The system 200 may include at least one processor 202. The at least one processor 202 may be a central processing unit (CPU) or other suitable processor(s). The system 200 may further include a memory 204 such as a random access memory (RAM), read only memory (ROM), or another suitable memory. The at least one processor 202 may execute a program stored on the memory 204 to determine angles, amplitudes, and distances as described above.

The system 200 also may include one or more input/output devices 206. The one or more input/output devices 206 may include a user input device, such as an input port and the like, a user output device, such as a speaker, and the like, an output port, a receiver, a transmitter, one or more storage devices, as well as various combinations thereof. The methods and processes described herein as implemented by the radar array 100 may be implemented with elements of the system 200.

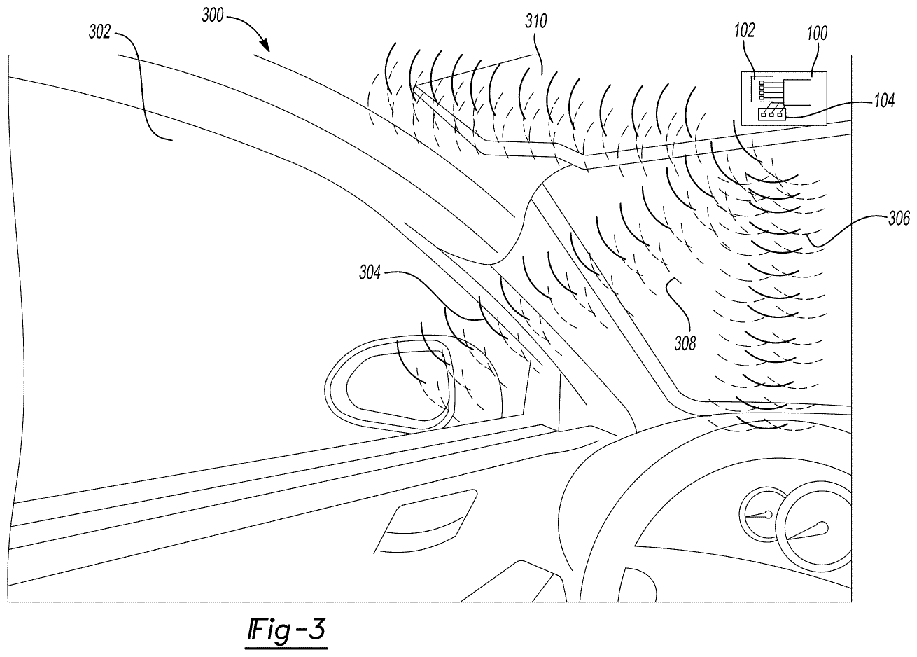

FIG. 3 is an illustration of a vehicle 300 including the radar array 100 of FIG. 1. The plurality of transmitter antennas 104 transmit signals towards a window 302 of the vehicle 300. While the signals are transmitted towards the window 302, at least a portion of the signals are also transmitted towards other portions of the vehicle 300 such as a portion of the door below and above the window 302 and towards a steering wheel of the vehicle 300. In the state illustrated in FIG. 3, the window 302 is intact. There may be a first plurality of signals 304, a second plurality of signals 306, and a third plurality of signals 308 transmitted by the plurality of transmitter antennas 104. The first plurality of signals 304 may be transmitted by a first transmitter antenna of the plurality of transmitter antennas 104, the second plurality of signals 306 may be transmitted by a second transmitter antenna of the plurality of transmitter antennas 104, and the third plurality of signals 308 may be transmitted by a third transmitter antenna of the plurality of transmitter antennas 104.

In at least one example embodiment, the radar array 100 may be positioned to orient the plurality of transmitter antennas 104 towards a driver's side window of a vehicle. Alternatively or additionally, the radar array 100 may be positioned such that the transmitter antenna of the plurality of transmitter antennas 104 may send signals towards a plurality of windows of a vehicle. For example, the radar array 100 may be used to monitor a status of all windows in a vehicle to determine if any of the windows have been broken. The radar array 100 may be placed on an interior roof 310 of the vehicle 300 in at least one example embodiment. To monitor each of the windows of a vehicle, the radar array 100 may be placed centrally within the interior of the vehicle 300. In at least one example embodiment, multiple radar arrays may be used to monitor all windows of the vehicle 300. For example, a radar array may be positioned above each window of the vehicle.

In at least one example embodiment, the radar array 100 may be positioned so that the plurality of transmitter antennas 104 are configured to transmit signals in other directions so that the radar array 100 is able to monitor other objects within the vehicle 300. For example, the radar array 100 may be configured to monitor a number of people located inside of the vehicle. In at least one example embodiment, the radar array 100 may be configured to determine if an accident has occurred by detecting broken glass while the vehicle 300 is running and/or while the vehicle 300 is occupied. In at least one example embodiment, the radar array 100 may be configured to notify emergency services upon detecting broken glass while the vehicle 300 is running and/or while the vehicle 300 is occupied.

In at least one example embodiment, the radar array 100 may be positioned so that the plurality of transmitter antennas 104 are configured to transmit signals in other directions so that the radar array 100 is able to monitor an exterior of the vehicle. For example, the radar array 100 may be able to monitor weather conditions exterior to the vehicle. The radar array 100 may be able to detect water or snow outside of the window 302 to identify flood conditions or avalanche conditions in at least one example embodiment. The radar array 100 may be able to determine the presence of snow or water outside the vehicle 300 based on a stronger reflection from the window 302.

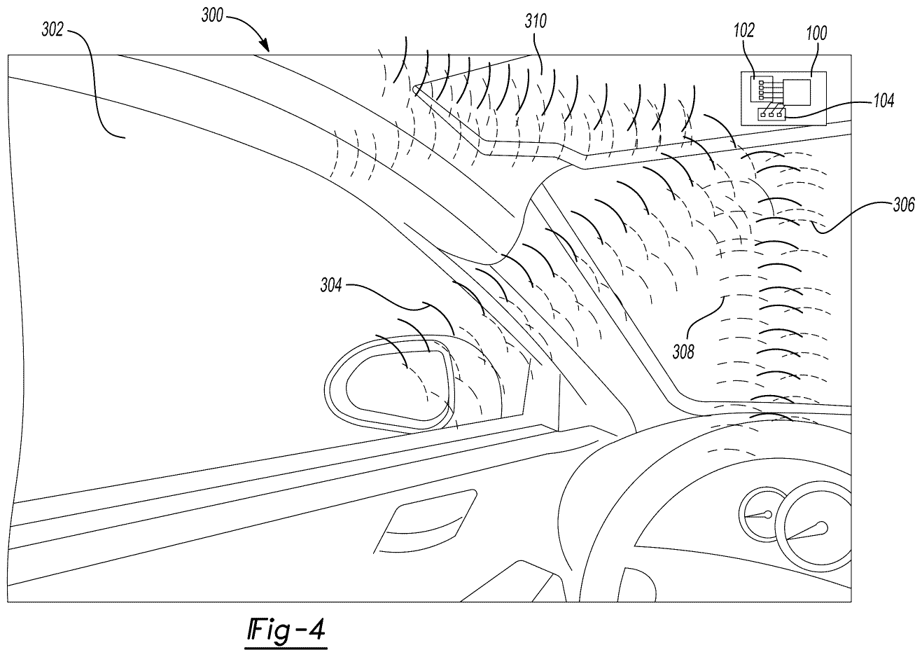

FIG. 4 is an illustration of the vehicle 300 with the radar array 100 receiving signals with the plurality of receiver antennas 102 while the window is intact. Each of the first plurality of signals 304, the second plurality of signals 306, and the third plurality of signals 308 transmitted by the plurality of transmitter antennas 104 have been reflected by the window 302 and/or other portions of the vehicle 300 such as the steering wheel and portions of the door above and/or below the window 302 and are being received by the plurality of receiver antennas 102. As described above, the positioning of each receiver antenna of the plurality of receiver antennas 102 is known which enables the radar array 100 to determine the angles along which the first plurality of signals 304, the second plurality of signals 306, and the third plurality of signals 308 propagate. In at least one example embodiment, an amplitude of each of the signals and a distance from the window 302 may also be determined by the radar array 100.

In at least one example embodiment, the angles along which the first plurality of signals 304, the second plurality of signals 306, and the third plurality of signals 308 propagate may be determined based on a phase shift detected when the signals are received at the plurality of receiver antennas 102. The signals transmitted by the plurality of transmitter antennas 104 may reflect off the window 302 or another object in a field of view of the plurality of transmitter antennas 104 and may be picked up or received by the plurality of receiver antennas. Because dimensions of each of the plurality of transmitter antennas 104 and the plurality of receiver antennas 102 are known, the radar array 100 may be configured to determine where the signals were reflected. The radar array 100 may be configured to determine a distance between the radar array 100 and the window 302 based on a time from transmission to reception of a signal utilizing the speed of light. For example, the distance between the radar array 100 and the window 302 may be calculated by the formula: D=(c×T)/2, where D is the distance between the radar array 100 and the window 302, c is the speed of light, and T is the time it takes for the signal to be transmitted, reflected, and received at the radar array 100. The radar array 100 may be configured to determine an amplitude based on how much energy from a transmitted signal is reflected back to the plurality of receiver antennas 102. In at least one example embodiment, a radar cross section may impact the energy that is reflected back to the plurality of receiver antennas 102. The radar cross section may include one or more of a size of a material that reflects a signal, a make-up or material that reflects a signal, and/or a distance between a transmitter

In at least one example embodiment, the radar array 100 may be configured to determine a baseline signal indicating a presence of the intact/unbroken window 302. The radar array 100 may be configured to determine a baseline signal received by the plurality of receiver antennas 102 when the window 302 is present and in a closed position with respect to the vehicle 300. Then, when the radar array 100 is operational, a window that is not intact (e.g., broken) may be detected if the signals received by the plurality of receiver antennas 102 differ by at least a threshold amount from the baseline signal. In at least one example embodiment, the radar array 100 may be configured to determine when the vehicle 300 is on or off. In at least one example embodiment, the radar array 100 may be operational when the vehicle is off as a method of theft detection when the vehicle is unoccupied. Alternatively or additionally, the radar array 100 may be operational both when the vehicle is on and when the vehicle is off to detect broken glass, occupancy, an accident, weather conditions, or other situations or events with respect to the vehicle 300. The radar array 100 may be configured to detect when the window 302 is broken, has been shattered in at least one pane, or if the window 302 is shattering. For example, no signal may be reflected if there is a hole in the window 302, a signal may be reflected as it would from a non-broken window when the window 302 is shattered but still in-tact, and a signal may return to the plurality of receiver antennas scattered if the window 302 is shattering.

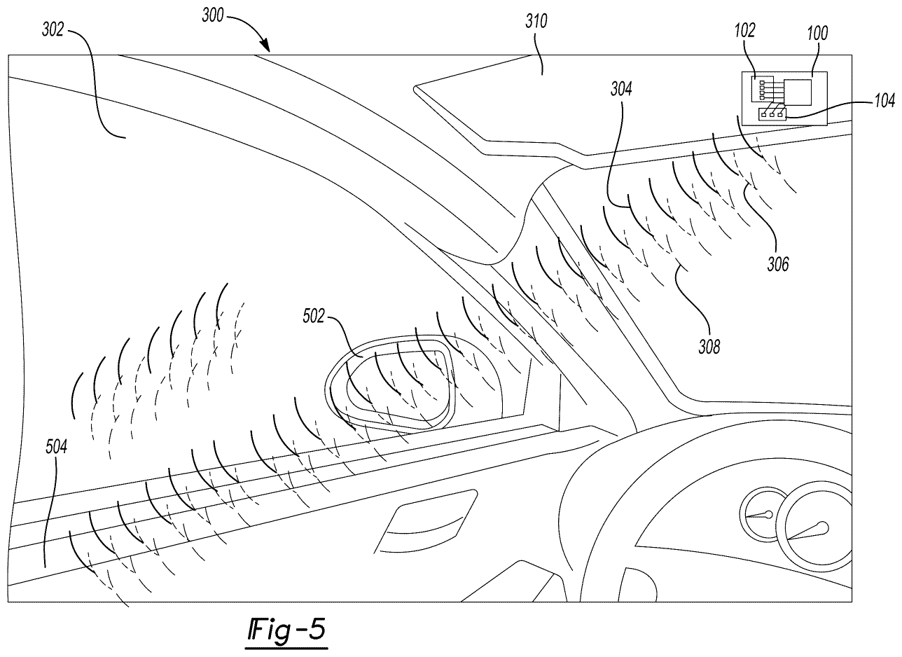

FIG. 5 is an illustration of the vehicle 300 including the radar array 100 of FIG. 1 transmitting signals while the window 302 of the vehicle is not intact. The plurality of transmitter antennas 104 are transmitting signals towards the window 302 of the vehicle. However, the window 302 is not intact meaning it is either broken or rolled down such that the signals are not reflecting off the window 302 as described above in FIGS. 3 and 4. As described above, the plurality of transmitter antennas 104 may transmit the first plurality of signals 304, the second plurality of signals 306, and the third plurality of signals 308. At least a portion of the first plurality of signals 304, the second plurality of signals 306, and the third plurality of signals 308 may radiate through where the window 302 should be if it were intact. There may be signals from the first plurality of signals 304, the second plurality of signals 306, and the third plurality of signals 308 that may be received and subsequently reflected from other objects of the vehicle 300 such as a door 502 or a mirror 504. In at least one example embodiment, the signals received from the door 502 may be consistent whether the window 302 is intact or not. However, the signals from the window 302 will no longer be received and additional signals such as signals reflected from the mirror 504 may be received.

In at least one example embodiment, the radar array 100 may be configured to determine when the window 302 is broken versus when the window is rolled down based on constant monitoring of the state of the window. As described above, when the window 301 is shattering, the signal may be scattered. The radar array 100 will log this scattering and know that the window 302 was broken. In contrast, if a window is rolled down, the radar array 100 will not receive a scattered signal and may receive signals with the plurality of receiver antennas showing motion of the window 302 as it is being rolled down.

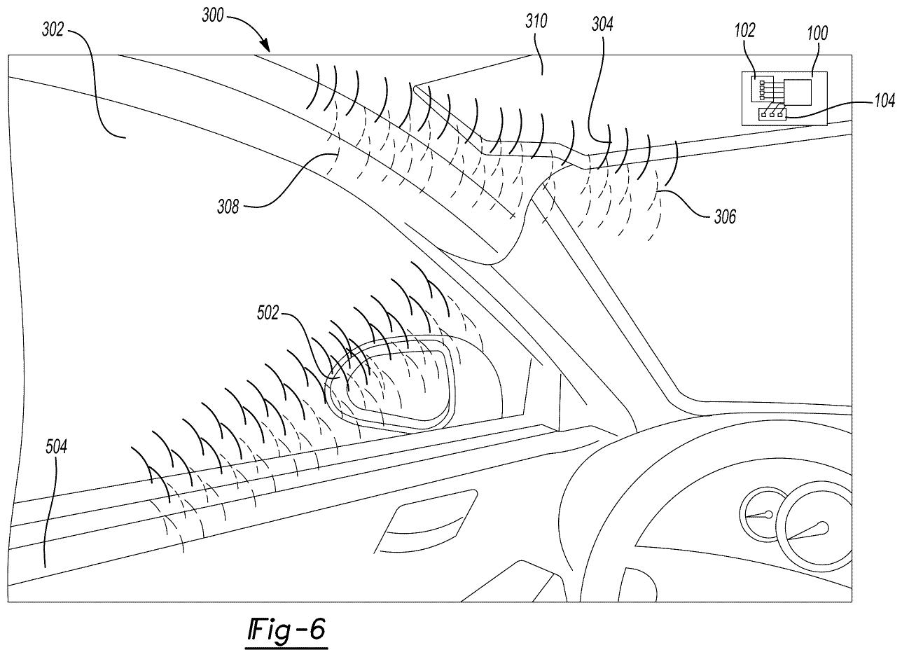

FIG. 6 is an illustration of the vehicle 300 with the radar array 100 receiving signals with the plurality of receiver antennas 102 while the window is not intact. Many of the first plurality of signals 304, the second plurality of signals 306, and the third plurality of signals 308 transmitted by the plurality of transmitter antennas 104 have been reflected by objects surrounding the window 302 and are being received by the plurality of receiver antennas 102. The reflected signals may differ from the baseline signal determined when the window 302 of the vehicle 300 was intact because they may be missing the reflected signals from the window 302 and may include reflected signals from objects beyond the window 302 such as the mirror 504. Thus, the radar array 100 may determine that the window 302 is not intact. In at least one example embodiment determining that the window 302 is intact may indicate that the window 302 has been broken. In at least one example embodiment, at least a portion of the first plurality of signals 304, the second plurality of signals 306, and the third plurality of signals 308 may not be received by the plurality of receiver antennas 102 because the signals may have been reflected in a direction away from the radar array 100 or they may have passed through an opening where an otherwise intact window would be located. Upon receiving reflected signals that do not match the baseline signal, the radar array 100 may determine that the window 302 is not intact.

In at least one example embodiment, a baseline signal may be determined from a plurality of measurements taken by the radar array 100 when the window 302 is not broken. In at least one example embodiment, the radar array 100 may also be configured to obtain a baseline signal for when the window 302 is broken. For example, one or more windows may be intentionally broken to enable measurements to be taken from a broken window. These measurements may be or may be used to determine a baseline signal for when the window 302 is broken. After the radar array 100 has the baseline signal measurements, it can be used to monitor an interior of a vehicle. In particular, the plurality of transmitter antennas 104 may transmit signals and the plurality of receiver antennas 102 may receive signals that have been reflected off objects within an interior of the vehicle. The radar array 100 may be configured to compare the signals received by the plurality of receiver antennas 102 to the baseline signals. If the signal differs from the baseline signal of the window 302 that is not broken, the signal may be compared to the baseline signal of a broken window or may send an alert that the window 302 is broken without a further comparison. In at least one example embodiment, the radar array 100 may utilize one or more machine learning algorithms to determine the baseline signals and/or determine a status of the window 302 based on a comparison to the baseline signals.

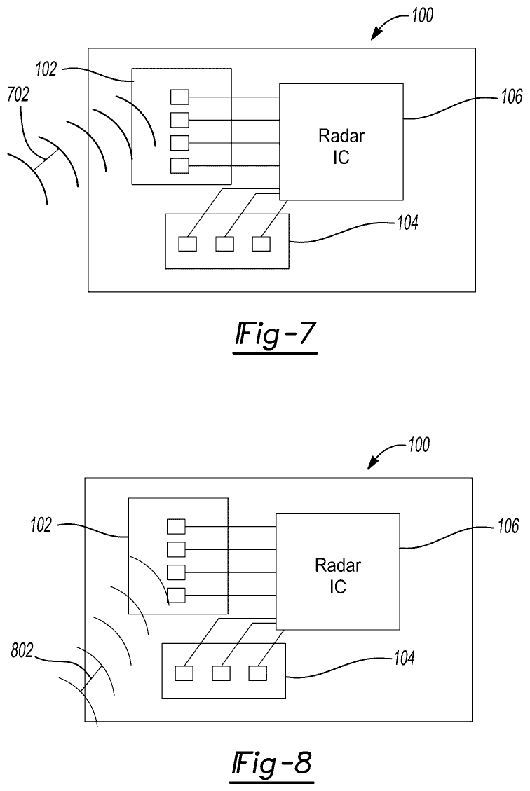

FIG. 7 shows the radar array 100 receiving the first plurality of signals 304 from an intact window. The first plurality of signals 304 may be spaced apart by a first distance 702. The first distance 702 may be at least one property of the baseline signal described above. Thus, when the distance between signals of the first plurality of signals 304 differs from the first distance 702, the radar array 100 may determine that the window is not intact. In at least one example embodiment, there may be a similar distance between signals of each of the second plurality of signals 306 and the third plurality of signals 308 and any additional signals transmitted by the plurality of transmitter antennas.

FIG. 8 shows the radar array 100 receiving the first plurality of signals 304 from a window that is not intact. The first plurality of signals 304 may be spaced apart by a second distance 802. The second distance 802 may be greater than the first distance 702. In at least one example embodiment, there may be a first time period between receipt of each of the first plurality of signals 304 by the plurality of receiver antennas 102 when the window is intact. Similarly, there may be a second time period between receipt of each of the first plurality of signals 304 by the plurality of receiver antennas 102 when the window is not intact. The second time period may be greater than the first time period. In at least one example embodiment, the angle of each of the first plurality of signals 304 may also differ when the window is not intact which may enable the radar array 100 to determine that the window 302 is broken.

FIG. 9 is a flow chart of a method 900 of detecting a window of a vehicle that is not intact. The method 900 will be described with respect to the radar array 100 and the vehicle 300 described above in FIGS. 1-8. The method 900 begins at block 902 where signals from the plurality of transmitter antennas are sent. The signals may include the first plurality of signals 304, the second plurality of signals 306, and the third plurality of signals 308 as described above. The signals may be reflected off one or more objects of the vehicle 300. As described above, if the window 302 is intact, the signals may be reflected off the window 302 and additional elements of the vehicle such as the door 502. If the window 302 is not intact, the signals may be reflected off the door 502, the mirror 504, and/or other components of the vehicle 300 surrounding or proximate to where the window 302 would be if it were intact but may not reflect off the window 302 with the same reflection as off the intact window.

At block 904, the reflected signals may be received by the plurality of receiver antennas 102. The reflected signals may be the first plurality of signals 304, the second plurality of signals 306, and the third plurality of signals 308 reflected off one or more elements of the vehicle 300 such as the window 302 when the window 302 is intact, the door 502, the mirror 504, and/or other components of the vehicle 300.

At block 906, the radar array 100 determines a status of the window 302. In particular, the radar array 100 may determine whether the window 302 is intact. As described above, the radar array 100 may have previously determined a baseline signal. The baseline signal may be signals transmitted by the plurality of transmitter antennas 104 and received by the plurality of receiver antennas 102 when the window 302 is intact. Then, the signals received by the plurality of receiver antennas 102 in block 904 may be compared to the baseline signal to determine whether the window is intact.

In at least one example embodiment, the method 900 may optionally further include transmitting a notification in response to determining that the window 302 is not intact. In at least one example embodiment, the radar array 100 may generate an alert by sending an alert to the vehicle and/or a user and/or emergency services in response to determining that the window 302 is not intact.

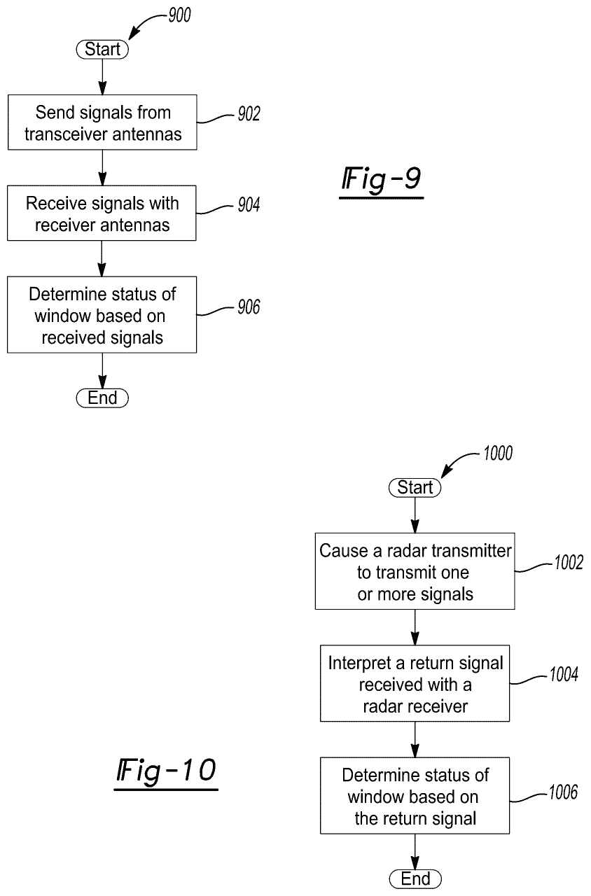

FIG. 10 is a flow chart of a method 1000 of detecting a condition of a window. The method 1000 will be described with respect to the vehicle 300 and the system 200 described above. The method 1000 begins at block 1002 where the at least one processor 202 causes a radar transmitter of the radar system to transmit one or more signals. The signals may be similar to the first plurality of signals 304, the second plurality of signals 306, and the third plurality of signals 308 as described above but may be transmitted by a single radar transmitter. The signals may be reflected off one or more objects of the vehicle 300. As described above, if the window 302 is intact, the signals may be reflected off the window 302 and additional elements of the vehicle such as the door 502. If the window 302 is not intact, the signals may be reflected off the door 502, the mirror 504, and/or other components of the vehicle 300 surrounding or proximate to where the window 302 would be if it were intact but may not reflect off the window 302 with the same reflection as off the intact window.

At block 1004, the at least one processor 202 may be configured to interpret a return signal received with a radar receiver. The return signal may include the reflected signals that were initially transmitted by the radar transmitter. In particular, the return signal may include signals reflected off one or more elements of the vehicle 300 such as the window 302 when the window 302 is intact, the door 502, the mirror 504, and/or other components of the vehicle 300.

At block 1006, the at least one processor 202 may be configured to determine, based on the return signal, a condition of the window. In particular, the at least one processor may determine whether the window 302 is intact, whether the window 302 is broken, whether the window 302 is rolled down, and/or whether the window 302 is partially rolled down. As described above, the radar system, via the at least one processor 202, may have previously determined one or more baseline signals. The one or more baseline signals may be signals transmitted by the radar transmitter and received by the radar receiver when the window 302 is intact and/or when a window is broken. Then, the signals received by the radar receiver and interpreted by the at least one processor 202 in block 1004 may be compared to the one or more baseline signals to determine a condition of the window 302.

In at least one example embodiment, the method 1000 may optionally further include transmitting, by the at least one processor 202, a notification in response to determining that the window 302 is not intact. In at least one example embodiment, the at least one processor 202 may generate an alert by sending an alert to the vehicle and/or a user and/or emergency services in response to determining that the window 302 is not intact.

The systems and methods described herein provide improved systems and methods for detecting whether a window of a vehicle is intact. The systems and methods described herein use a single system or array to determine whether a window is intact. Further, the systems and methods described herein enable a radar array or other sensor configured to send and receive an RF signal to determine a location of an object and to determine whether the object remains in a particular location. Thus, the systems and methods described herein are configured to determine whether a window of a vehicle is intact and also whether a vehicle is occupied and/or a weather condition outside of the vehicle. Thus, the systems and methods described herein improve vehicle safety both when there are occupants within the vehicle and when the vehicle is unoccupied.

In some cases, the radar array 100 or radar system may be positioned to detect the presence of an occupant in a vehicle, such as the presence of a child or a pet to avoid leaving children or pets in overheated vehicles during hot weather. In such an embodiment, the radar system, via the plurality of transmitter antennas 104, may direct a first radar signal in a first direction towards an occupant seat for occupancy detection. The first radar signal may be reflected back towards a radar receiver such as the plurality of receiver antennas 102. A processor of the radar system, such as the at least one processor 202, may process the reflected signal to determine the presence of an occupant. Further, the radar system may also be programmed to send, via the plurality of transmitter antennas 104, a second radar signal in a second direction towards a window of the vehicle. The second radar signal may be reflected back to the radar receiver. The second reflected back signal may be processed to determine a condition of the vehicle.

In some examples, the radar system may be able to detect movement of the window. For example, the radar system may be able to detect when the window is in the process of being rolled up or rolled down. Additionally, the radar system may be able to detect movement of glass as the glass is flexing, cracking, being cut, or breaking into small fragments. In some cases, the radar signal may be programmed to recognize fragments of glass shards moving inward into the vehicle interior as the window 302 is being broken.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A radar array for detecting whether a window of a vehicle is intact, the radar array comprising:
a plurality of transmitter antennas, each of the plurality of transmitter antennas configured to transmit a signal; and
a plurality of receiver antennas, each of the plurality of receiver antennas configured to receive the signals transmitted by the plurality of transmitter antennas,
wherein the radar array is configured to be installed at a location within the vehicle and to detect whether the window is intact based on the signals received by the plurality of receiver antennas.

2. The radar array of claim 1, wherein there are more receiver antennas in the plurality of receiver antennas than transmitter antennas in the plurality of transmitter antennas.

3. The radar array of claim 1, wherein the radar array is configured to determine a baseline signal received by the plurality of receiver antennas when the window is intact.

4. The radar array of claim 3, wherein the plurality of receiver antennas are configured to detect when the window is not intact by comparing the signals received by the plurality of receiver antennas to the baseline signal.

5. The radar array of claim 1, wherein the radar array is further configured to generate an alert upon determining that the window is broken.

6. The radar array of claim 1, wherein the signals transmitted by each of the plurality of transmitter antennas are radio frequency (“RF”) signals.

7. The radar array of claim 6, wherein the RF signals are between about 60 GHz and 144 GHz.

8. A method for detecting whether a window of a vehicle is intact, the method comprising:
installing a radar antenna at a location in the vehicle, the radar antenna including a plurality of transmitter antennas and a plurality of receiver antennas;
sending signals from each transmitter antenna of the plurality of transmitter antennas;
receiving at least some of the signals from the plurality of transmitter antennas with the plurality of receiver antennas; and
determining whether the window is intact based on the signals received by the plurality of receiver antennas.

9. (canceled)

10. The method of claim 8, further comprising:
determining a baseline signal received by the plurality of receiver antennas when the window is not broken.

11. The method of claim 10, wherein determining whether the window is intact includes comparing the signals received at each of the plurality of transmitter antennas to the baseline signal.

12. The method of claim 8, further comprising:
determining an orientation of the window based on a location of the plurality of receiver antennas and the signals received by each antenna of the plurality of receiver antennas.

13. The method of claim 12, wherein determining the orientation of the window includes determining an angle of the window based on the signals received by each antenna of the plurality of receiver antennas and an amplitude of the signals received by each antenna of the plurality of receiver antennas while the window is intact.

14. The method of claim 8, further comprising:
generating an alert upon determining that the window is not intact.

15. A radar system for detecting a condition of a window, the radar system comprising:
a sensor including a radar transmitter configured to send one or more signals and a radar receiver configured to receive the one or more signals sent by the radar transmitter, the sensor being disposed at a location within a vehicle including the window;
a processor in communication with the radar transmitter and the radar receiver; and
a memory in communication with the processor, where the memory includes instructions configured, when executed by the processor, to cause the processor to
send an instruction to cause the radar transmitter to transmit one or more signals towards the window from within the vehicle,
interpret a return signal received with the radar receiver, and
determine, based on the return signal, a condition of the window.

16. The radar system of claim 15, wherein the processor is further configured to determine a baseline signal received by the radar receiver when the window is intact.

17. The radar system of claim 16, wherein the processor is further configured to detect that the window is not intact by comparing the one or more signals received by the radar receiver to the baseline signal.

18. The radar system of claim 15, wherein the processor is further configured to generate an alert upon determining that the window is not intact.

19. The radar system of claim 15, wherein the signal transmitted by the radar transmitter is a radio frequency (“RF”) signal.

20. The radar system of claim 19, wherein the RF signal is between about 60 GHz and 144 GHz.

21. The radar array of claim 1, wherein the location within the vehicle is at least one of an interior roof of the vehicle, a center of an interior of the vehicle, or in the interior of the vehicle above the window.
